(19) United States
(12) Patent Application Publication
(10) Pub. No.: US 2002/0047985 A1
(43) Pub. Date: Apr. 25, 2002

(54) Adjustable eyeglass frame

(76) Inventor: Jack L. Hollins, Lexington, KY (US)

Correspondence Address: OSTROLENK FABER GERB & SOFFEN, 1180 AVENUE OF THE AMERICAS, NEW YORK, NY, 100368403

(21) Appl. No.: 09/816,886

(22) Filed: Mar. 23, 2001

Related U.S. Application Data
(60) Provisional application No. 60/191,675, filed on Mar. 23, 2000.

(51) Int. Cl. G02C 5/16

(52) U.S. Cl. 351/114

(57) ABSTRACT

A eyeglass frame which includes an adjusting mechanism that allows the position of the temple pieces to be manually adjusted to accommodate different head sizes and to prevent the spring loaded temple pieces from pressing against the temples of the wearer. An optional feature allows the length of the temple pieces to be similarly adjusted to accommodate different human heads.

### BACKGROUND OF THE INVENTION

The present invention relates generally to eyeglasses and, more particularly, to eyeglass frames which provide improved adjustability for more comfortable wear.

It has long been known to make spring loaded hinges for eyeglasses. This keeps the earpiece from being bent each time the eyeglasses are taken off.

Unfortunately, the hinges start off at 90° angles to the lenses and if the frame is fit poorly, and the patient's head is larger and separates the hinge more than 90°, then the spring causes the earpiece to be pressed against the temple very tightly and uncomfortably.

Secondly, it has long been known that temple pieces and earpieces may be provided with mechanisms that allow them to be lengthened or shortened. Various types of these mechanisms are on the market, for example, those that snap from one hole to another and those that screw into position. However, existing mechanisms are less sturdy, more difficult to use and do not provide all of the comfort that eyeglass wearers require.

### SUMMARY OF THE INVENTION

It is an object of the present invention to provide an adjustable eyeglass frame that can be adjusted to control or remove the pressure exerted by a temple piece of eyeglasses against the head of a person.

It is another object of the present invention to provide an improved mechanism that allows the temple piece and earpiece to be lengthened or shortened in an easy and reliable manner.

The foregoing and other objects of the invention are realized in accordance with one aspect of the invention wherein the hinge joining the temple piece and the nose piece frame has a screw at the side of the hinge which is attached to a bar affixed to the temple piece. By turning the screw, the bar then presses against the temple piece and moves it out or in depending on the direction of desired adjustment. The earpieces fit the patient and do not press upon his/her head. Once the screw is adjusted so that the earpieces have their proper width adjustment, they still have the same spring abilities that they had before. The spring hinge, therefore, puts no pressure on the side of a patient's head, but does give a full range of motion of the spring as well as being more comfortable to wear.

In accordance with the second aspect of the invention, the temple and earpieces of the eyeglasses are constructed such that the temple piece has a female threaded hole for receiving a screw and the male piece has a join-in screw-like component that can be screwed into the temple piece to form a length-adjustable temple piece. In use, the male earpiece is screwed into the female temple piece to adjust the length and once the desired length has been reached, a screw “nut” on the male portion screw shank is capable of being tightened against the female piece to cause the earpiece to be stable and locked into position to prevent lateral rotation. The entire area is then covered with a silicon sleeve of the ear pads so that the adjusting structure is not visible when the frames are adjusted properly.

Other features and advantages of the present invention will become apparent from the following description of the invention which refers to the accompanying drawings.

### BRIEF DESCRIPTION OF THE DRAWINGS

FIG. 1 shows an eyeglass wearer.

FIG. 2 shows a portion of the eyeglasses constructed in accordance with the present invention, including the lateral adjustability of the temple/earpieces to adjust for a patient's head size.

FIG. 3 illustrates the range of movement of the eyeglass rim of the present invention.

FIG. 4 illustrates the mechanism of the hinge.

FIG. 5 shows the manner of lengthening the temple/earpieces through the use of an adjustable screw-in mechanism.

FIG. 6 shows a tightening nut and a tool for locking the earpiece relative to the temple piece.

FIG. 7 further illustrates the mechanism of the temple/earpiece lengthening arrangement.

FIG. 8 shows the temple/earpiece in position on an ear of a patient.

FIG. 9 shows the manner in which the sleeve covers the tightening mechanism.

FIG. 10 shows the operation of the covering sleeve.

FIG. 11 shows the rear view of the eyeglass frame on a person.

FIGS. 12a and 12b show prior art hinge and spring mechanisms for eyeglass frames.

FIGS. 12c, 12d and 12e shown a second embodiment of the present invention.

FIGS. 13a, 13b and 13c show a third embodiment of the present invention.

### DETAILED DESCRIPTION OF EMBODIMENTS OF THE INVENTION

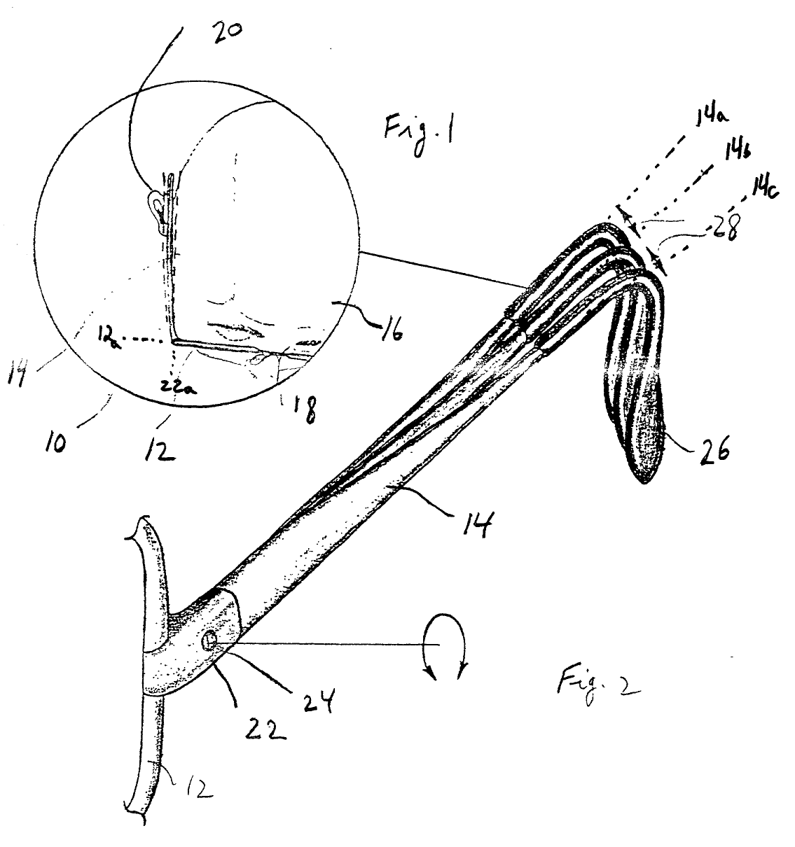

With reference to the drawings, FIG. 1 shows an eyeglass frame 10 with a nose piece frame portion 12 and a temple piece 14. A person 16 wears the eyeglasses with the nose piece 12 supported on the nose 18 and with the ear piece locking behind the ear 20.

Referring to FIG. 2, the nose piece frame 12 has firmly attached to it a hinge anchor 22 which has a adjusting screw 24 which allows the temple piece 14 to be adjusted laterally in accordance with the direction indicated by the arrows 28 so as to assure that the temple piece 14 and the earpiece 26 are laterally moveable to avoid pressing on the temple of the person 16.

Generally, the frame 12 lies in a first plane 12a (FIG. 1) that extends perpendicularly to the paper surface on which the Figure is drawn. The hinge 22 lies generally in a second frame 22a, similarly extending perpendicularly to the paper, as well as perpendicularly to the first plane 12a. The plane in which the temple piece 14 lies at its rest position is adjustable by the present invention through the turning of the adjusting screw 24 as already noted. In FIG. 2, the planes 14a, 14b, and 14c can be used to designate both the rest position of the plane in which the temple piece 14 lies, or the continuous movement of the piece 14 in response to an application of force applied laterally to the plane 22a, allowing the temple piece to move out resiliently, due to a spring (not shown in FIGS. 1-3) which provides such spring action, as well-known in the prior art.

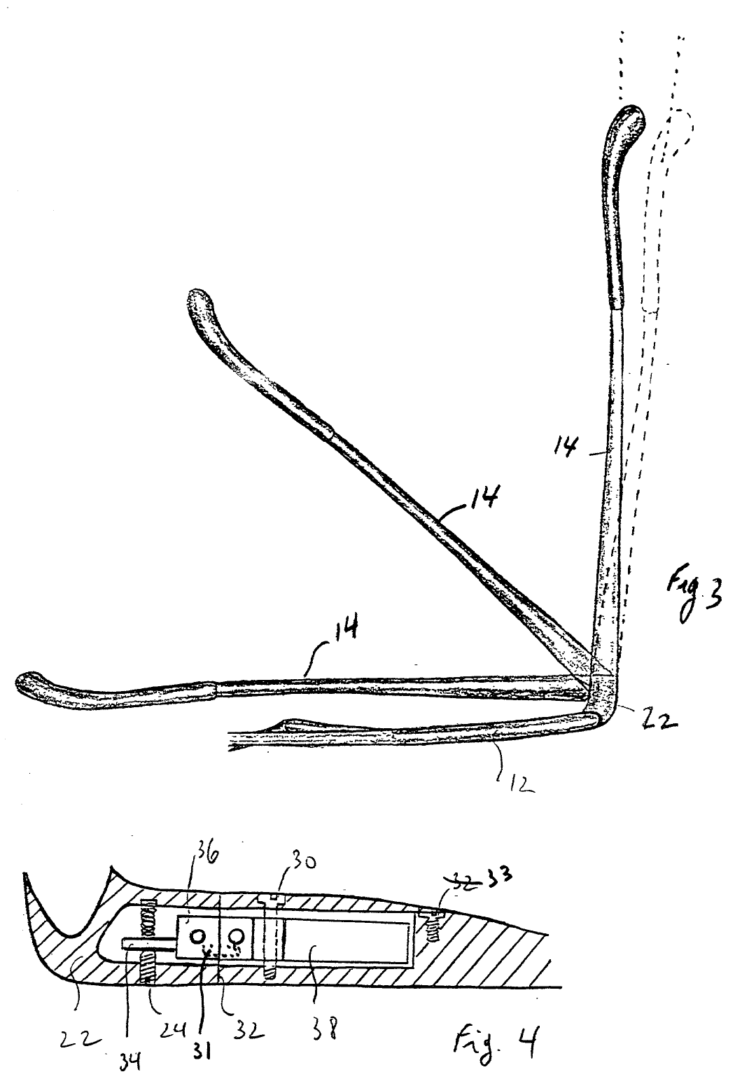

Referring to FIG. 3, the screw 24 is used to adjust the gorest position, i.e., the unbiased position of the earpiece 14. However, the functionality of the temple piece 14 is not compromised inasmuch as the temple piece still can be positioned at 90° relative to the nose piece frame 12 or parallel thereto as indicated in FIG. 3. The flexing against the spring of the temple piece is not altered as indicated by dashed line in FIG. 3.

Turning to FIG. 4, note the bar 34 against which the adjusting screw 24 presses as well as the spring (unnumbered). The bar 34 is connected to a first piece 36 which extends to the separation line 32 between the pieces 22 and the temple piece 14. The screws 30 and 33 and the bar 38 provides further adjusting and stability for the mechanism.

Turning to the expedient of adjusting the length of the temple piece 14, note that the temple piece 14 has a threaded receiving hole into which a screw 40 of the earpiece 26 is attached. The earpiece 26 is turned and thereby threaded into the temple piece 14 thereby adjusting the overall length “L” of the temple/earpieces as shown. It is advantageous to construct a mechanism such that each full turn of the screw 40 causes a ½ mm adjustment in the distance “L.”

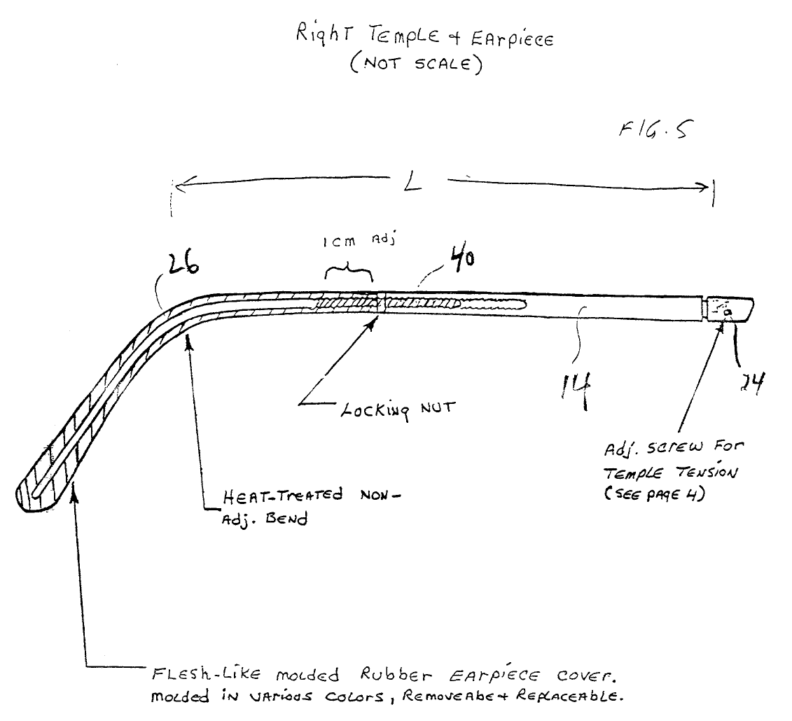

Referring to FIG. 6, once the proper length has been achieved, a tool 44 is used to adjust a nut 42 so that it comes to bear against the end portion or rear surface of the temple piece 14 via a locking washer (not shown) so that the position of the earpiece 26 becomes fixed to prevent lateral and uncomfortable rotation thereof relative to the temple piece. Once the adjustment has been made, a sleeve component 45 is turned over, covering the tightening screw 42 as well as the lock washer as indicated in FIG. 8.

With the mechanism of the present invention, once tightened with the nut 42, the earpiece 26 no longer can be rotated clockwise or counter-clockwise (as indicated by the arrows 47 in FIG. 7) after an optimal position of the earpiece 26 has been achieved as indicated in FIG. 8 by means of the arrows 46.

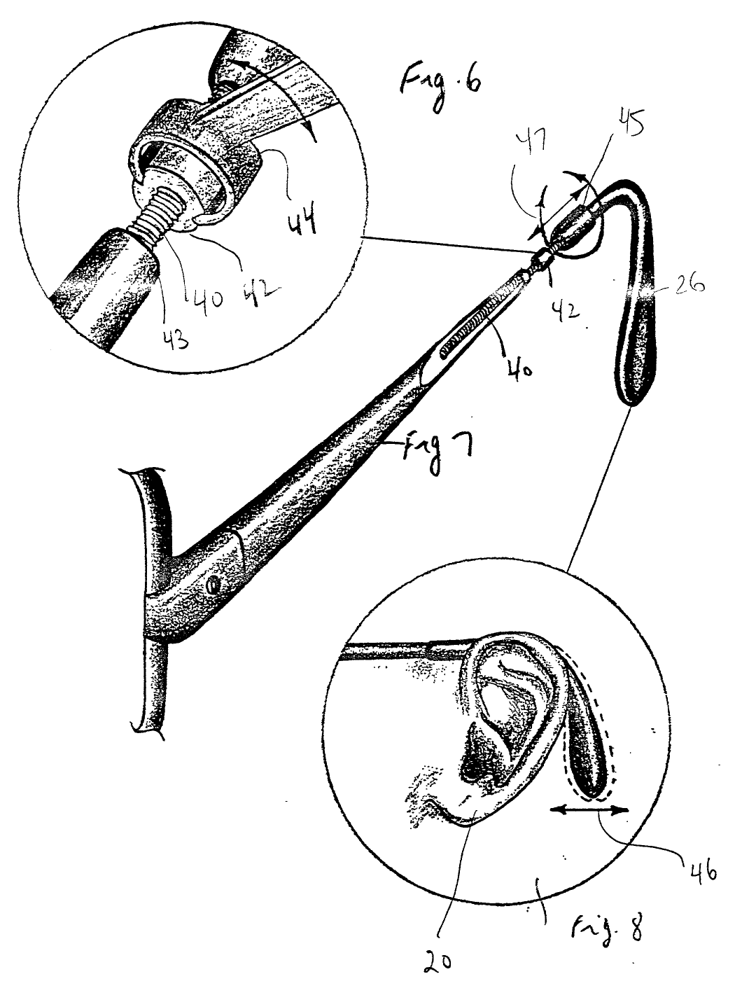

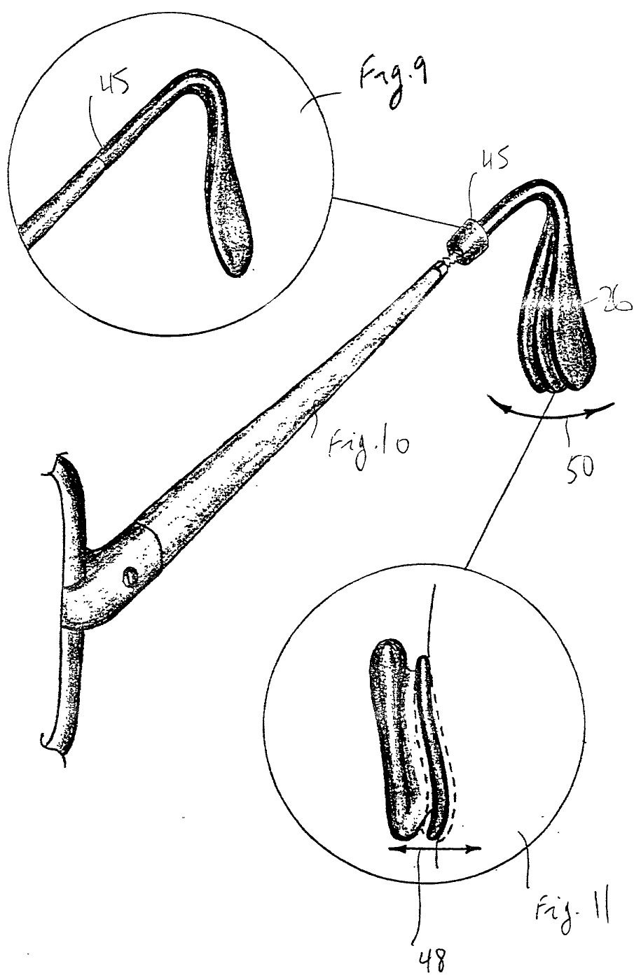

The utility of the present invention is further illustrated in FIGS. 9-11 which further illustrate that, once tightened, the earpiece 26 cannot be moved in the direction of the arrows 50 (FIG. 10) or direction 48 in FIG. 11.

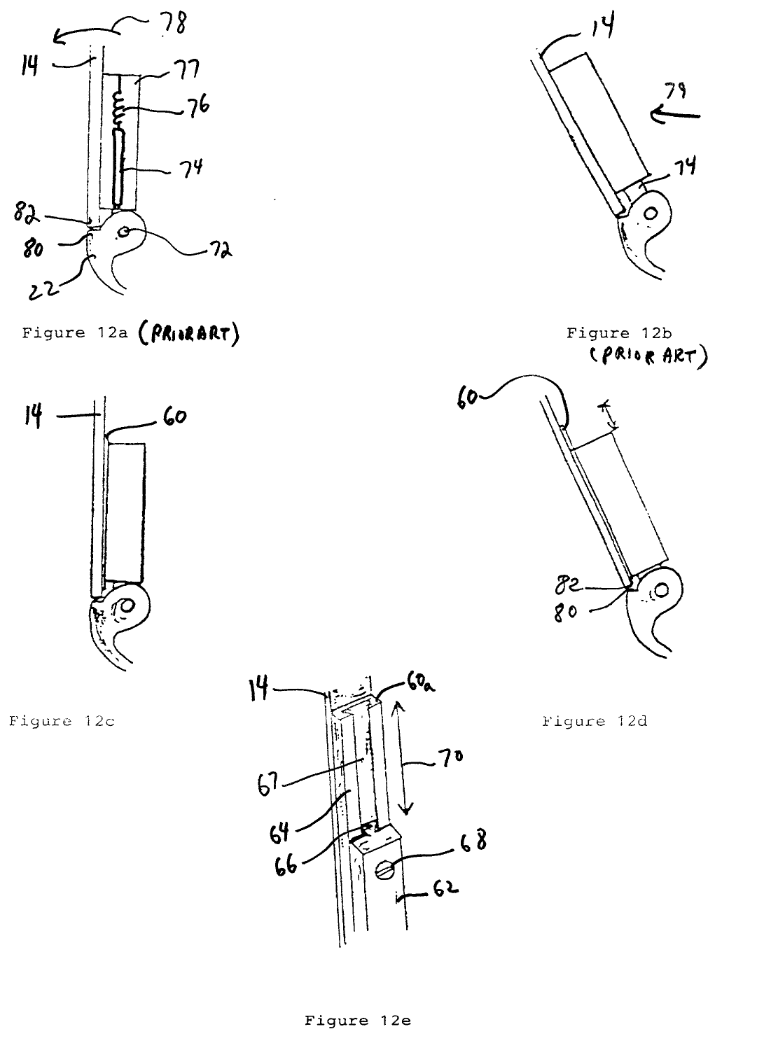

With reference to FIGS. 12a-12e, another embodiment to the invention that allows adjusting the rest position of the temple pieces 14 is described below.

FIGS. 12a and 12b show the prior art. The temple piece 14 and the hinge anchor 22 are joined to one another by a movable rod 74 that is connected at one end thereof to a pivot/hinge 72. The rod 74 is resiliently anchored to the temple piece 14 via a spring 76 which is anchored to a block 77 that is itself rigidly attached to the piece 14. FIG. 12a shows the rest position of the piece 14, relative to the plane of anchor 22. In this rest or “wearing” position, the plane of the temple piece 14 is coextensive with the plane of the hinge anchor 22, and approximately perpendicular to the plane of the frame 12.

As shown in FIG. 12b, applying a lateral force 79 to the block 77, causes the rod 74 to become extended outside the block 77, allowing the plane of the temple piece 14 to assume an angle (about 30°) relative to the plane of the hinge anchor 22. The end 82 (FIG. 12a) rests against a stop 80 on the hinge anchor 22.

The present invention modifies FIGS. 12a and 12b by providing a coupling structure 60, which allows the position of the block 77 on the temple piece 14 to be adjusted as shown in FIGS. 12d and 12e.

With reference to FIG. 12d, the coupling structure 60 includes a grooved channel 60a and a modified block 62 with a tongue 68 that is slidable within the channel 67 of the piece 60a. A set screw 68 can be tightened to fix the position of the block 62 relative to the member 60a. Thus, the relative position can be adjusted up and down as indicated by the arrow 70. The result of the adjustment is indicated in FIG. 12d, whereby the rest position of the temple piece 14 now extends at an appreciable angle relative to the plane of the hinge anchor 22, allowing a person with a wider face to wear the glasses without the force of the spring 76 pulling the temple pieces 14 tightly against the temples of the person, avoiding discomfort.

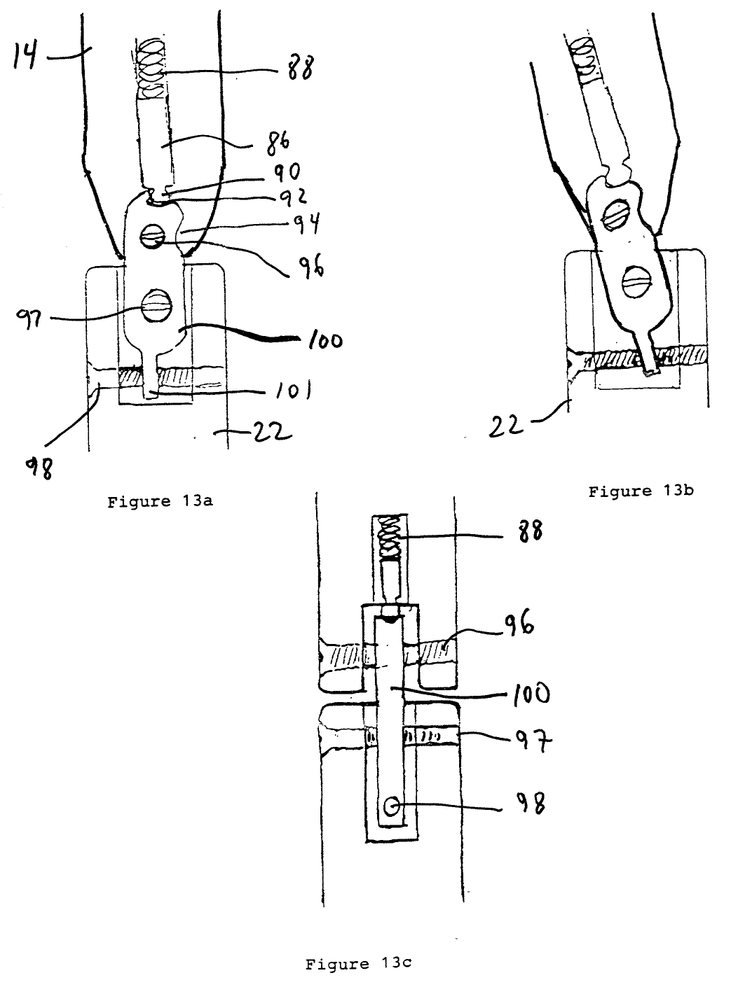

Yet another embodiment of the temple piece adjustment mechanism is illustrated in FIGS. 13a through 13c. Referring to FIG. 13c, the temple piece 14 is mechanically coupled to the hinge anchor 22 by a plate 100, with the piece 14 being pivotally connected via pivot screw 96 that allows the temple piece 14 be fully extended in an open, wearing position or pivoted to a closed position in the manner shown in FIG. 3. In this embodiment, there is also provided a pair of snap-in fixed positions for the temple piece 14. The first detent 92 and the second detent 94 receive the resiliently-biased spring pin 86, which has a head 90 that snaps into the aforementioned detents snugly due to the spring action provided by the spring 88. Thus, the frame “holds” its opened and closed or folded positions.

If the plate 100 were rigidly attached to the hinge anchor 22, there would be only a single angle (approximately 90°) at which the temple piece 14 would extend (and hold its position) relative to the plane of the hinge anchor 22. However, FIG. 13a connects the plate for 100 via a pivot 97 and the plate 100 further has a tongue 101 that is movable laterally by rotating the adjusting screw 98. In this manner, the entire plate 100 can be pivoted, as shown in FIG. 13b, allowing the wearing position of the temple piece 14 to be at an angle relative to the plane of the hinge anchor 22. In one arrangement, the tongue 101 has an internally threaded screw hole which receives the externally threaded adjusting screw 98. A cross section of FIG. 13a is depicted in FIG. 13c.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An eyeglass frame, comprising:
a front frame for supporting lens, the front frame having a left end and a right end and being generally contained in a first plane;
first and second temple pieces;
a respective hinge anchor at each end of the front frame, each hinge anchor serving to couple a respective one of the temple pieces to the front frame;
the hinge anchor extending along and being substantially contained in a second plane which extends substantially perpendicular to the first plane of the front frame; and
the first and second temple pieces being pivotable between a wearing position and a folded position and including a mechanism that allows the wearing position of the first and second temple pieces to be adjusted in a manner whereby a third plane, which contains the first temple piece, is angled relative to the second plane.

2. The frame of claim 1, further including a spring arrangement that allows pivoting of the temple pieces away from the wearing position by an angular range of up to about 30°.

3. The frame of claim 1, further including an adjusting screw for adjusting the angle of the wearing position of the temple pieces relative to the second plane of the hinge anchor.

4. The frame of claim 3, in which the adjusting screw extends perpendicularly to the second plane.

5. The frame of claim 3, including a connecting plate coupled to the adjusting screw.

6. The frame of claim 5, in which the coupling plate has an end member with an internally threaded opening through which the adjusting screw passes, in a manner whereby when the adjusting screw is turned the angle is adjusted.

7. The frame of claim 2, in which the spring arrangement comprises a pivot fixed in the hinge anchor, a rod coupled at one end thereof to the pivot, a spring member connected to an opposite side of the rod, the spring being anchored in a block that is connected to the temple piece.

8. The frame of claim 7, in which in the block is rigidly connected to the temple piece.

9. The frame of claim 8, in which the block is slidable relative to the temple piece and including a fixing mechanism for fixing a selected position of the block relative to the temple piece.

10. The frame of claim 9, in which the fixing mechanism comprises a set screw.

11. The frame of claim 5, further including a pivot passing through both the connecting plate and a first end of the temple piece and enabling the temple piece to pivot relative to the connecting plate.

12. The frame of claim 11, in which the connecting plate has first and second detents and the temple plate has a detent snap-in member that can snap into a first one of the detents when the frame is in the wearing position and into the second detent when the frame is in the folded position.

13. The frame of claim 12, further including a spring for resiliently biasing the detent member against the connecting plate.

14. An eyeglass frame, comprising:
a front frame for supporting lens, the front frame having a left end and a right end and being generally contained in a first plane;
first and second temple pieces;
a respective hinge anchor at each end of the front frame, each hinge anchor serving to couple a respective one of the temple pieces to the front frame;
the hinge anchor extending along and being substantially contained in a second plane which extends substantially perpendicular to the first plane of the front frame; and
first and second earpieces attached, respectively, to the first and second temple pieces by being screwed into a threaded opening at an ear-end of the first and second temple pieces.

15. The frame of claim 14, further including a tightening nut that is turnable on the threaded end of the first and second earpieces, and which bears against the respective end of the first and second temple pieces, to lock the earpiece in a given position.

16. The frame of claim 15, further including a sleeve component that can be turned over to cover the nut.

17. The frame of claim 16, in which tightening of the nut prevents clockwise or counterclockwise rotation of the corresonding earpiece.

18. The frame of claim 14, in which the first and second temple pieces are pivotable between a wearing position and a folded position and include a mechanism that allows the wearing position of the first and second temple pieces to be adjusted in a manner whereby a third plane, which contains the first temple piece, is angled relative to the second plane.
